(19) United States
(12) Patent Application Publication
(10) Pub. No.: US 2015/0022880 A1
(43) Pub. Date: Jan. 22, 2015

(54) IMAGE MEASURING APPARATUS WITH AUTOMATED CONTROL OF VARIABLE-POWER NOSE WHEEL ROTATION AND 3D DISPLACEMENT

(71) Applicant: ARCS PRECISION TECHNOLOGY CO., LTD., Taichung City (TW)

(72) Inventor: YING-YING SHIH, TAICHUNG CITY (TW)

(21) Appl. No.: 13/947,227

(22) Filed: Jul. 22, 2013

(51) Int. Cl. G02B 21/24

(52) U.S. Cl. CPC G02B 21/24
USPC 359/381

(57) ABSTRACT

An image measuring apparatus with an automated control of variable-power nose wheel rotation and 3D displacement includes a base on a work table on a floor, a platform on the base and having first and second moving parts for controlling the platform moving along X-axis and Y-axis respectively, an upright column on the base and a side of the platform and having a third moving part capable of moving along Z-axis, and a measuring lens group disposed on and displaced with the third moving part. The control device includes a control program for controlling the displacement of the first and second moving parts to change the position of the platform, controlling the displacement of the third moving part to change the position of the measuring lens group, and controlling the measuring lens group to switch to an objective microscope to a different magnification to achieve a fully automated measurement.

### FIELD OF THE INVENTION

The present invention relates to an image measuring apparatus, and more particularly to the image measuring apparatus with fully automated measurement and high expandability.

### BACKGROUND OF THE INVENTION

In general, a conventional image measuring apparatus has a measuring platform capable of moving horizontally in X-axis and Y-axis and a measuring lens capable of moving vertically in Z-axis, such that the image measuring apparatus can be adjusted to the most suitable position by the three-axis displacements for the observation of a sample.

However, the displacement adjusting structure of the platform and the lens of the aforementioned conventional image measuring apparatus is operated by turning a couple of knobs manually. In other words, mechanical transmission devices are used to control the displacements of the platform and the lens, and such control method generally has insufficient precision, and fail to fine-tune a very small distance of the displacements, and it is relatively difficult for users to adjust the platform and the lens to the best observing position to observe a very small sample.

Furthermore, the measuring lens of the conventional image measuring apparatus has an upright column hanged from the top of the platform to carry out a measurement, but the fixed shape and size of the upright column limits the platform at a fixed position above, and the size of the platform is also limited, so that a platform of a different size does not fit in the same machine and the conventional measuring apparatus is lack of expandability.

In view of the abovementioned problem, the inventor of the present invention based on years of experience in the related field to conduct extensive researches and experiments, and finally invented the present invention to overcome the problem of the prior art.

### SUMMARY OF THE INVENTION

In view of the aforementioned problem of the prior art, it is a primary objective of the present invention to provide an image measuring apparatus with an automated control of variable-power nose wheel rotation and 3D displacement, wherein a control device is used for controlling a platform and a measuring lens group to move automatically the X-axis, Y-axis and Z-axis and control the measuring lens group to automatically select the required lens and light source, and a measuring software program is further provided to achieve a fully automated measurement so as to provide a more quickly and simpler measuring operation and improve the accuracy of measurement.

Another objective of the present invention is to change the distance between the measuring lens group and the upright column according to different sizes of platforms, so that the same machine can adopt platforms of various different sizes to improve the expandability and lower the cost.

To achieve the aforementioned objective, the present invention provides an image measuring apparatus with an automated control of variable-power nose wheel rotation and 3D displacement, and the image measuring apparatus comprises a platform provided for placing an object to be measured, an upright column, a measuring lens group and a control device, characterized in that the platform is disposed on a base, and the base is disposed on a work table on a floor, and the platform includes a first moving part and a second moving part, and the two moving parts are provided for driving the platform to move in two directions along the mutually perpendicular X-axis and Y-axis on the base respectively; the upright column is disposed on the base and on a side of the platform, and the upright column has a third moving part capable of moving in a height-wise direction along the Z-axis of the upright column; the measuring lens group is disposed on the third moving part and extended to a position above the platform and capable of moving with the third moving part, and the measuring lens group includes a rotatable nose wheel and a light source, and the nose wheel includes a plurality of objective microscopes with different magnifications, and the light source provides a light intensity required by the objective microscopes for a measurement operation; and the control device is electrically coupled to the first, second and third moving parts, the nose wheel and the light source, and the control device has a control software program provided for automatically controlling the displacements of the first and second moving parts in order to change the position of the platform, automatically controlling the position of the third moving part to change the position of the measuring lens group, automatically controlling the rotation of the nose wheel to switch to an objective microscope of a different magnification, and automatically controlling the light source to provide a light of a different intensity.

Wherein, the control device is a computer which further includes a measuring software program installed therein and operated in conjunction with the control software program for a fully automated measurement.

Wherein, the measuring lens group further includes an image capturing device.

Wherein, the image measuring apparatus further comprises at least one selectively detachable connecting part installed between the third moving part and the measuring lens group.

Wherein, the image measuring apparatus further comprises at least one selectively detachable extension part installed between the upright column and the third moving part.

### BRIEF DESCRIPTION OF THE DRAWINGS

FIG. 1 is a perspective view of the present invention;

FIG. 2 is a schematic planar view of the present invention; and

FIG. 3 is a schematic planar view of the present invention at another using status.

### DESCRIPTION OF THE PREFERRED EMBODIMENTS

The technical characteristics, contents, advantages and effects of the present invention will be apparent with the detailed description of a preferred embodiment accompanied with the illustration of related drawings as follows.

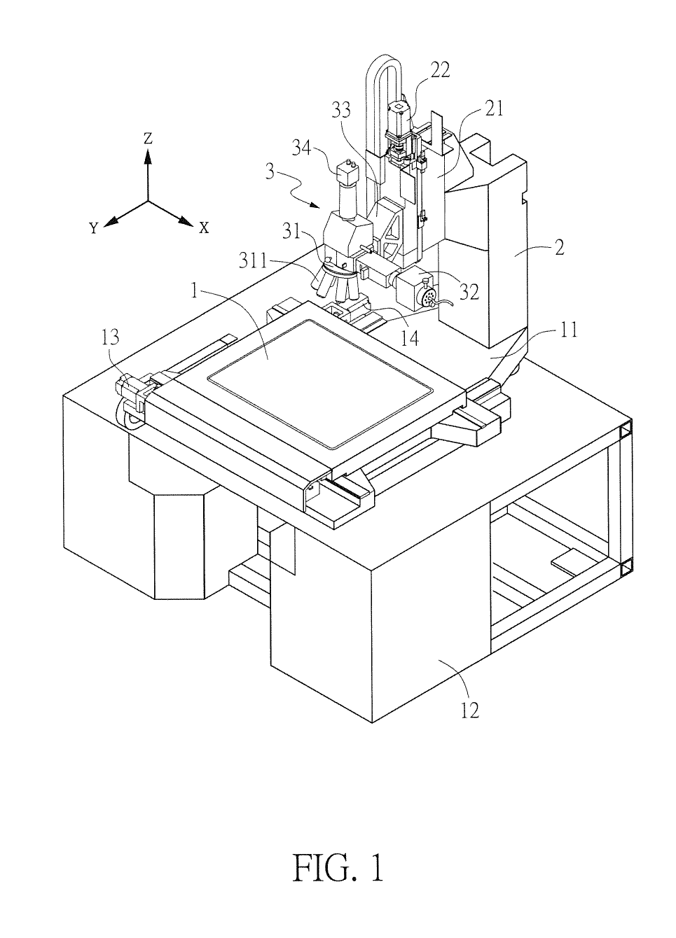

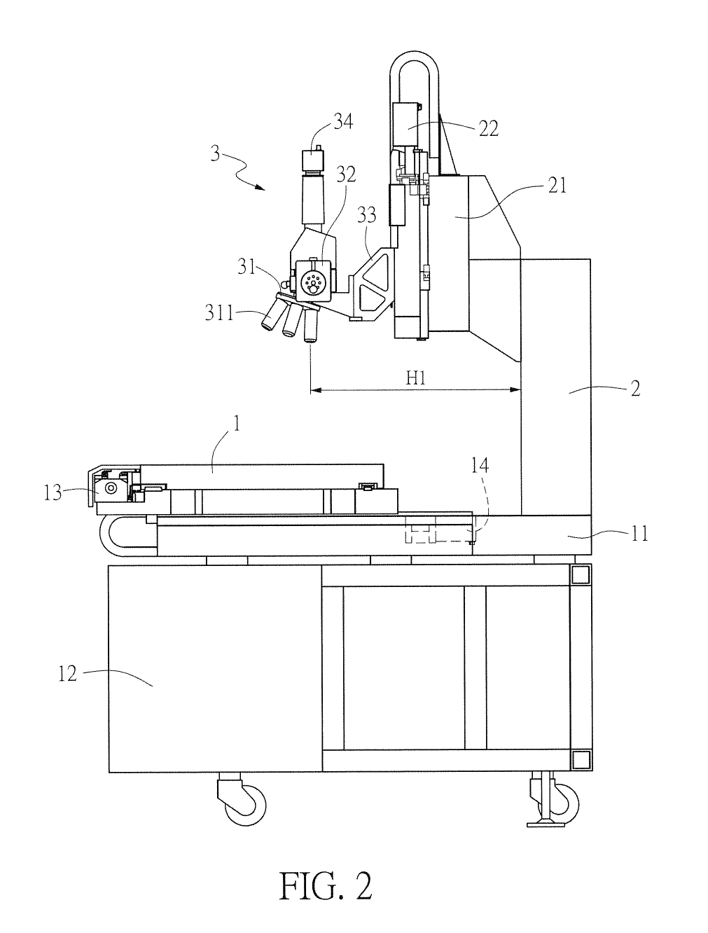

With reference to FIGS. 1 and 2 for an image measuring apparatus of the present invention, the image measuring apparatus comprises a platform 1 provided for placing an object to be measured, an upright column 2, a measuring lens group 3 and a control device (not shown in the figure), wherein the platform 1 is disposed on a base 11, and the base is fixed on a work table 12 on a floor, and three axial directions of the base 11 mutually perpendicular to one another are defined, and these axial directions includes a X-axis and a Y-axis on the same plane, and a Z-axis perpendicular to both of the X-axis and Y-axis, and the platform 1 includes a first moving part 13 and a second moving part 14 for driving the platform 1 to move in directions along the X-axis and the Y-axis on the base 11 respectively.

The upright column 2 is disposed on a side of the platform 1 and on the base 11, and the upright column 2 is extended upwardly in a direction along the Z-axis. The upright column 2 includes a third moving part 22 capable of moving in a direction along the Z-axis and the vertically up and down in the height-wise direction of the upright column 2, and the measuring lens group 3 is installed above the third moving part, so that the measuring lens group 3 can be driven by the third moving part to displace vertically up and down with respect to the platform 1. The measuring lens group 3 comprises a rotatable nose wheel 31 and a light source 32, wherein the nose wheel 31 includes a plurality of objective microscopes 311 with different magnifications, and the nose wheel 31 can be rotated to switch to a different objective microscope 311, and the light source 32 provides a light intensity required by the objective microscope 311 for a measurement operation. In this preferred embodiment, the measuring lens group 3 further includes an image capturing device 34 for capturing a required image obtained by the observation through the microscope 311.

The first, second and third moving parts 13, 14, 22, the nose wheel 31 and the light source 32 are electrically coupled to the control device (not shown in the figure), wherein the control device of this preferred embodiment is a computer. The computer includes a control software program, so that after coordinates information is received, the computer controls the displacement of the first and second moving parts 13, 14 through the control software program, and the platform 1 can displace along the directions of the X-axis and Y-axis with respect to the base 11 and the computer also controls the displacement of the third moving part 22, so that the measuring lens group 3 can move along the direction of the Z-axis with respect to the platform 1. The computer further controls the nose wheel 31 to rotate and switch to an objective microscope 311 of a different magnification or controls the light emitting power of the light source 32 and provides lights of different intensities for different measurement requirements. In this preferred embodiment, the computer further includes a measuring software program used for a measurement operation to achieve a fully automated measurement without any manual operation for moving the platform and the measuring lens group or selecting the lens. Therefore, the invention makes the measurement operation quicker, simpler, and more convenient, and also improves the accuracy of the measurement through the automated control.

To cope with different sizes of the objects to be measured, the platform 1 also comes with different sizes, wherein a larger object to be measured requires a larger platform for carrying. If different sized platforms 1 are disposed on the same base 11 at the same time, the distance between the measuring lens group 3 and the upright column 2 must be changed in order to provide sufficient room to move the platform 1. In this preferred embodiment of the present invention as shown in FIGS. 1 and 2, at least one selectively detachable connecting part 33 is installed between the third moving part 22 and the measuring lens group 3, and at least one selectively detachable extension part 21 is installed between the upright column 2 and the third moving part, and both of the connecting part 33 and the extension part 21 can provide a longer distance H1 between the measuring lens group 3 and the upright column 2 to fit a larger-size platform 1.

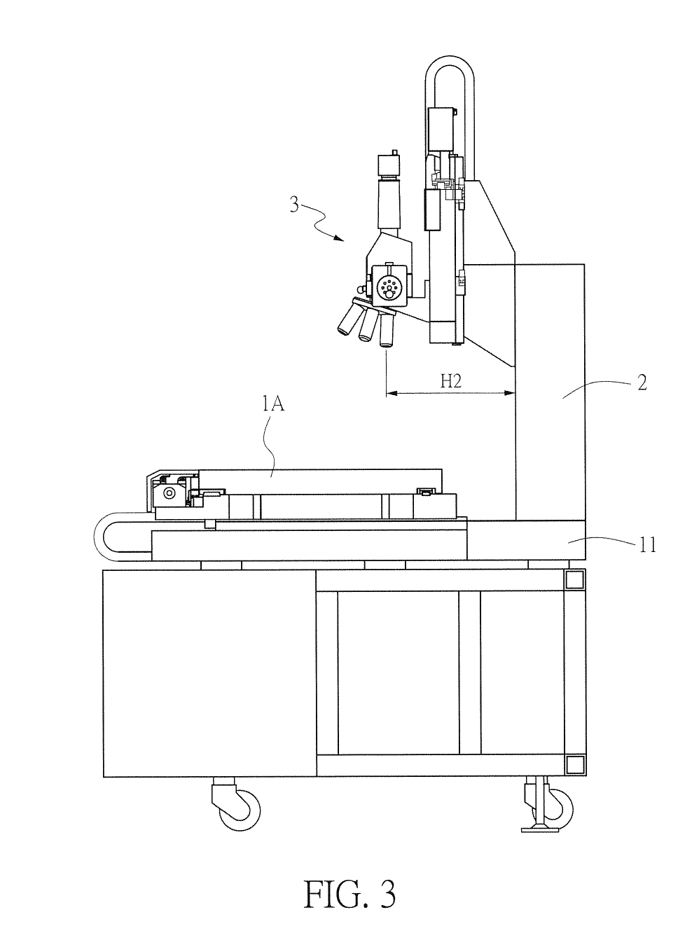

If a smaller-size platform 1A is installed on the same base 11 as shown inn FIG. 3 and the connecting part 33 and the extension part 21 are removed, the distance H2 between the measuring lens group 3 and the upright column 2 will be decreased to fit a smaller-size platform 1A.

Since the present invention comes with a detachable design of the connecting part 33 and the extension part 21, therefore the connecting part 33 and the extension part 21 can be selectively installed or removed to meet the requirements for different sized platforms, so that the same machine can fit various different sized platforms to improve the expandability and lower the cost.

What is claimed is:

1. An image measuring apparatus with an automated control of variable-power nose wheel rotation and 3D displacement, comprising a platform provided for placing an object to be measured, an upright column, a measuring lens group and a control device, characterized in that the platform is disposed on a base, and the base is disposed on a work table on a floor, and the platform includes a first moving part and a second, driving the platform to move in two directions along the mutually perpendicular X-axis and Y-axis on the base respectively; the upright column is disposed on the base and on a side of the platform, and the upright column has a third moving part capable of moving in a height-wise direction along the Z-axis of the upright column; the measuring lens group is disposed on the third moving part and extended to a position above the platform and capable of moving with the third moving part, and the measuring lens group includes a rotatable nose wheel and a light source, and the nose wheel includes a plurality of objective microscopes with different magnifications, and the light source provides a light intensity required by the objective microscopes for a measurement operation; and the control device is electrically coupled to the first, second and third moving parts, the nose wheel and the light source, and the control device has a control software program provided for automatically controlling the displacements of the first and second moving parts in order to change the position of the platform, automatically controlling the position of the third moving part to change the position of the measuring lens group, automatically controlling the rotation of the nose wheel to switch to an objective microscope of a different magnification, and automatically controlling the light source to provide a light of a different intensity.

2. The image measuring apparatus with an automated control of variable-power nose wheel rotation and 3D displacement according to claim 1, wherein the control device is a computer which further includes a measuring software program installed therein and operated in conjunction with the control software program for a fully automated measurement.

3. The image measuring apparatus with an automated control of variable-power nose wheel rotation and 3D displacement according to claim 1, wherein the measuring lens group further includes an image capturing device.

4. The image measuring apparatus with an automated control of variable-power nose wheel rotation and 3D displacement according to claim 1, further comprising a selectively detachable connecting part installed between the third moving part and the measuring lens group.

5. The image measuring apparatus with an automated control of variable-power nose wheel rotation and 3D displacement according to claim 1, further comprising at least one selectively detachable extension part installed between the upright column and the third moving part.
